(19) United States
(12) Patent Application Publication
(10) Pub. No.: US 2024/0120702 A1
(43) Pub. Date: Apr. 11, 2024

(54) SERVO MATCHING CONTROL MID-INFRARED DIFFERENTIAL DUAL-WAVELENGTH LASER BASED ON MULTI-PERIOD ND:MGO:PPLN

(71) Applicant: CHANGCHUN UNIVERSITY OF SCIENCE AND TECHNOLOGY, Changchun, Jilin (CN)

(72) Inventors: Yongji Yu, Changchun, Jilin (CN); Guangyong Jin, Changchun, Jilin (CN); Yuheng Wang, Changchun, Jilin (CN); Rui Zhao, Changchun, Jilin (CN); Chao Wang, Changchun, Jilin (CN); Yuan Dong, Changchun, Jilin (CN)

(21) Appl. No.: 18/263,705

(22) PCT Filed: Jul. 6, 2021
(86) PCT No.: PCT/CN2021/104811

§ 371 Date: Jul. 31, 2023

(30) Foreign Application Priority Data
Feb. 2, 2021 (CN) 202110146059.1

(51) Int. Cl. H01S 3/08; H01S 3/00; H01S 3/0933; H01S 3/16

(52) U.S. Cl. CPC H01S 3/0809; H01S 3/0071; H01S 3/0933; H01S 3/1611; H01S 3/1671

(57) ABSTRACT

Disclosed is a servo matching control mid-infrared differential dual-wavelength laser based on Nd:MgO:PPLN, The 813 nm semiconductor pumping source, the energy transmitting optical fiber, the first focusing lens, the second focusing lens, the first 45-degree beam splitter, the mid-infrared idle frequency light output mirror, the polarized crystal, the servo motor, the mid-infrared parametric light total reflection mirror, the microprogrammed control unit, the second 45-degree beam splitter, the electro-optical crystal and the 1093 nm fundamental frequency light total reflection mirror are sequentially placed from right to left in a straight cavity of the laser; and the 1084 nm fundamental frequency light total reflection mirror is placed in a bent-shape cavity of the laser, corresponding to a position of the second 45-degree beam splitter, such the second 45-degree beam splitter can reflect incident light to the 1084 nm fundamental frequency light total reflection mirror.

### TECHNICAL FIELD

The present disclosure relates to the field of laser, and in particular to a servo matching control mid-infrared differential dual-wavelength laser based on multi-period ND:MGO:PPLN.

### BACKGROUND

The 3-5 μm mid-infrared spectral band is the main band in the atmospheric transmission window, and it has broad application prospects in numerous military and civilian fields such as spectrum sensing, environmental monitoring, medical diagnosis, and optoelectrionic countermeasures. The mid-infrared band covers the absorption peaks of a large number of inorganic molecules and organic molecules, and has great unique advantages in the detection of atmospheric pollution. The mid-infrared differential laser radar uses dual-wavelength mid-infrared lasers generated to respectively match the peak and trough of the absorption spectrum of the gas to be detected, and then forms a differential detection, thereby allowing the concentration of the gas to be detected to be accurately calculated through the feedback of echo signals. It has the characteristics of high spatial resolution, fast scanning speed and high detection sensitivity, therefore it is widely used in remote sensing detection of the atmosphere, ocean and land. It can perform real-time measurement of the concentration of widely-distributed gases, like CO₂, SO₂, NO₂. However, the conventional mid-infrared differential absorption laser radar is of single wavelength and multi-beam combination, has complex structure and poor synchronous matching of gas molecule absorption spectra, therefore it is of great significance for promoting technological progress to create a mid-infrared differential dual-wavelength laser with free control of differential dual-wavelengths, rapid switching of wavelength matching, and compact structure.

At present, the Nd:MgO:PPLN polarized crystal comprising Nd³⁺ ions doped with MgO has functionally integrated fundamental frequency gain and quasi-phase matching frequency conversion characteristics. The fundamental frequency light gain and mid-infrared laser frequency conversion jointly use the same Nd:MgO:PPLN crystal, the 1084 nm/1093 nm orthogonally polarized dual-wavelength fundamental frequency light generated by the crystal directly forms by pumping itself in the cavity, and dual-wavelength mid-infrared parametric light can be obtained. This self-conversion frequency application technology greatly reduces the structural volume of the dual-wavelength mid-infrared laser. In the current reports on Nd:MgO:PPLN self-conversion frequency, the Nd:MgO:PPLN crystal is effectively controlled to alternately output 1084 nm and 1093 nm fundamental frequency orthogonally polarized dual-wavelength laser, as set forth in the paper “Yuheng Wang, Yongji Yu, Dehui Sun, et al. Study on the regulation mechanism of orthogonally polarised dual-wavelength laser based on Nd³⁺ doped MgO:LiNbO₃. Optics and Laser Technology, 2019, 119:105570-105570”. When using multi-period Nd:MgO:PPLN polarized crystal self-conversion frequency to output mid-infrared laser, in the oscillation optical paths of 1084 nm and 1093 nm fundamental frequency light, multiple groups of mid-infrared parametric light can be obtained by changing the spatial position of corresponding Nd:MgO:PPLN channels. Based on this, the present disclosure proposes to use multi-period Nd:MgO:PPLN as frequency self-conversion medium, drive the servo control system through alternating resonance signals of 1084 nm/1093 nm orthogonally polarized fundamental frequency light, and switch between different periodic channels of Nd:MgO:PPLN crystal rapidly and precisely according to the absorption spectrum of the gas to be detected. This allows differential wavelength matching, thereby achieving the invention goal of a structurally compact integrated multi-channel mid-infrared differential wavelength laser, which allows wavelengths to be controlled and freely matched.

### SUMMARY

In order to address the above problems, the present disclosure provides a servo matching control mid-infrared differential dual-wavelength laser based on multi-period ND:MGO:PPLN. By adjusting a Q-switching device in the resonant cavity and a laser crystal, it can output mid-infrared differential dual-wavelength laser, breaking through the technical limitation that conventional mid-infrared light parametric oscillators cannot switch between periodic channels through electric control of multi-period crystal's movement, and also solving the problems of complex structure and low integration level of the current mid-infrared differential dual-wavelength laser.

The present disclosure provides a servo matching control mid-infrared differential dual-wavelength laser based on multi-period ND:MGO:PPLN, comprising: an 813 nm semiconductor pumping source, an energy transmitting optical fiber, a first focusing lens, a second focusing lens, a first 45-degree beam splitter, a mid-infrared idle frequency light output mirror, a multi-period Nd:MgO:PPLN polarized crystal, a servo motor, a mid-infrared idle frequency light total reflection mirror, a microprogrammed control unit, a second 45-degree beam splitter, an electro-optical crystal, a 1093 nm fundamental frequency light total reflection mirror, and a 1084 nm fundamental frequency light total reflection mirror,
wherein the 813 nm semiconductor pumping source, the energy transmitting optical fiber, the first focusing lens, the second focusing lens, the first 45-degree beam splitter, the mid-infrared idle frequency light output mirror, the multi-period Nd:MgO:PPLN polarized crystal, the servo motor, the mid-infrared idle frequency light total reflection mirror, the microprogrammed control unit, the second 45-degree beam splitter, the electro-optical crystal, and the 1093 nm fundamental frequency light total reflection mirror are sequentially placed from right to left in a straight cavity of the laser;
wherein the 1084 nm fundamental frequency light total reflection mirror is placed in a bent-shape cavity of the laser, corresponding to a position of the second 45-degree beam splitter, such that that the second 45-degree beam splitter reflects incident light to the 1084 nm fundamental frequency light total reflection mirror.

According to some embodiments of the present disclosure, the 813 nm semiconductor pumping source is configured to emit pumping light;
the energy transmitting optical fiber is configured to sequentially transmit the pumping light to the first focusing lens and the second focusing lens;
the first focusing lens and the second focusing lens are configured to form a zoom coupling lens group to adjust a size of pumping light spot focused on an end face of the multi-period Nd:MgO:PPLN polarized crystal;
the first 45-degree beam splitter is configured to allow the pumping light to be transmitted through and reflect mid-infrared idle frequency light;
the mid-infrared idle frequency light output mirror is configured to allow the pumping light to be transmitted through, reflect 1084 nm/1093 nm fundamental frequency light, and output mid-infrared idle frequency light;
the multi-period Nd:MgO:PPLN polarized crystal is configured to generate 1084 nm/1093 nm fundamental frequency light under a pumping action of the pumping light, and output mid-infrared idle frequency light;
the servo motor is configured to realize reciprocal movement of the multi-period Nd:MgO:PPLN polarized crystal under a control of the microprogrammed control unit, so as to realize switching of crystal periods;
the mid-infrared idle frequency light total reflection mirror is configured to allow the 1084 nm/1093 nm fundamental frequency light to be transmitted through, and reflect the mid-infrared idle frequency light;
the microprogrammed control unit is configured to control a rotation speed of the servo motor, and send electrical signals to the electro-optical crystal;
the second 45-degree beam splitter is configured to reflect the 1084 nm fundamental frequency light to the 1084 nm fundamental frequency light total reflection mirror, and allow the 1093 nm fundamental frequency light to be transmitted to the 1093 nm fundamental frequency light total reflection mirror;
the electro-optical crystal is configured to improve a stimulated emission area for the 1093 nm fundamental frequency light, and realize a mid-infrared differential wavelength output;
the 1093 nm fundamental frequency light total reflection mirror is configured to reflect the 1093 nm fundamental frequency light.

According to some embodiments of the present disclosure, the mid-infrared idle frequency light output mirror, the mid-infrared idle frequency light total reflection mirror and the multi-period Nd:MgO:PPLN polarized crystal constitute an idle frequency light resonant cavity;
the first 45-degree beam splitter, the idle frequency light resonant cavity, the second 45-degree beam splitter and the 1084 nm fundamental frequency light total reflection mirror constitute a 1084 nm fundamental frequency light resonant cavity;
the first 45-degree beam splitter, the idle frequency light resonant cavity, the second 45-degree beam splitter, the electro-optical crystal, and the 1093 nm fundamental frequency light total reflection mirror constitute a 1093 nm fundamental frequency light resonant cavity.

According to some embodiments of the present disclosure, the 813 nm semiconductor pumping source has a wavelength of 813 nm, a fiber core radius of 200 μm, and a numerical aperture of 0.22.

According to some embodiments of the present disclosure, the first 45-degree beam splitter is coated with a high-transmittance film for 813 nm fundamental frequency light and a high-reflection film for mid-infrared idle frequency light.

According to some embodiments of the present disclosure, the mid-infrared idle frequency light output mirror is a flat mirror coated with a high-transmittance film for 1084 nm/1093 nm fundamental frequency light and idle frequency light.

According to some embodiments of the present disclosure, the multi-period Nd:MgO:PPLN polarized crystal is cut in an a-axis, with a crystal size of: thickness×width×length=2 mm×6 mm×40 mm, a doping concentration of MgO is set to 5%, and a doping concentration of Nd³⁺ ions is set to 0.4%, and the multi-period Nd:MgO:PPLN polarized crystal is coated at two ends with a high-transmittance film for pumping light and fundamental frequency light and a high-transmittance film for idle frequency light.

According to some embodiments of the present disclosure, the mid-infrared idle frequency light total reflection mirror is a flat mirror coated with a high-reflection film for idle frequency light and a high-transmittance film for 1084 nm/1093 nm fundamental frequency light; the 1093 nm fundamental frequency light total reflection mirror and the 1084 nm fundamental frequency light total reflection mirror are plano-concave mirrors coated with high-reflection films for 1084 nm/1093 nm fundamental frequency light.

According to some embodiments of the present disclosure, the second 45-degree beam splitter is coated with a high-reflection film for 1084 nm fundamental frequency light and a high-transmittance film for 1093 nm fundamental frequency light.

According to some embodiments of the present disclosure, the electro-optical crystal is coated with a 1093 nm laser anti-reflection film, and a λ/4 voltage is applied to two ends of the electro-optical crystal.

The beneficial effects of the technical solutions provided by the embodiments of the present disclosure lie in: based on the fact that the multi-period Nd:MgO:PPLN polarized crystal takes on the characteristic of fundamental frequency light phenomenon, the present disclosure ensures that cavity structure parameter designs of two fundamental frequency light resonant cavities in the straight cavity and the bent-shape cavity of the laser do not interfere with each other, while taking into account the integration and the compactness, and an MCU (Microprogrammed Control Unit) is used to control the servo motor to drive the multi-period Nd:MgO:PPLN polarized crystal to move vertically to switch between different crystal periodic channels; at the same time, the MCU (Microprogrammed Control Unit) is used to precisely load voltage to the electro-optical crystal to realize the output of multiple groups of mid-infrared differential dual-wavelength laser frequencies. The present disclosure breaks through the restriction that the conventional mid-infrared light parametric oscillators based on multi-period crystal cannot match and switch between crystal periodic channels with high precision and rapidly. The disclosed system can not only switch between different periodic channels of Nd:MgO:PPLN crystal rapidly and precisely according to the absorption spectrum of the gas to be detected, to realize differential wavelength matching, but also solves the problem of complex structure of the current mid-infrared differential dual-wavelength laser, thereby promoting the development of mid-infrared dual-wavelength lasers with a high degree of optical-mechanical-electronic-computer integration.

It should be appreciated that the foregoing general description and the following detailed description are only exemplary and explanatory, but are not construed as limiting the present disclosure.

### BRIEF DESCRIPTION OF THE DRAWINGS

Other features, objects and advantages of the present disclosure will become more apparent through the following detailed description of nonrestrictive embodiments in conjunction with the accompanying drawings. In the drawings:

FIG. 1 is a schematic structural view of a servo matching control mid-infrared differential dual-wavelength laser based on multi-period ND:MGO:PPLN according to an embodiment of the present disclosure.

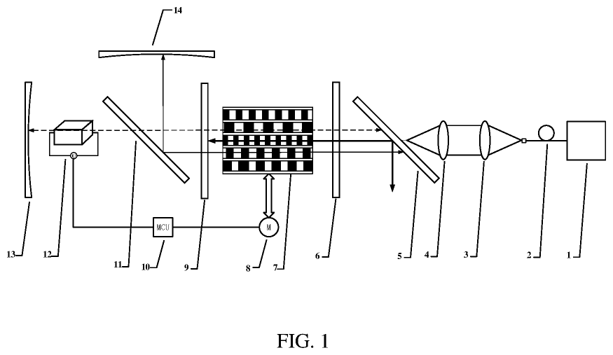

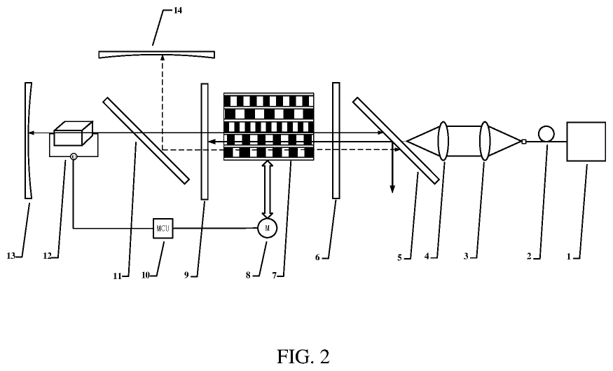

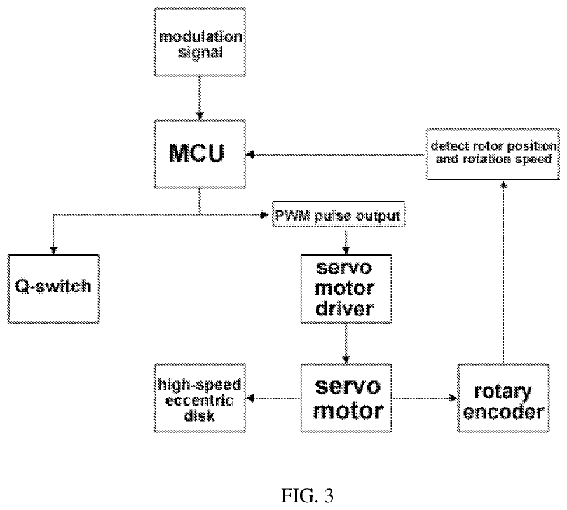

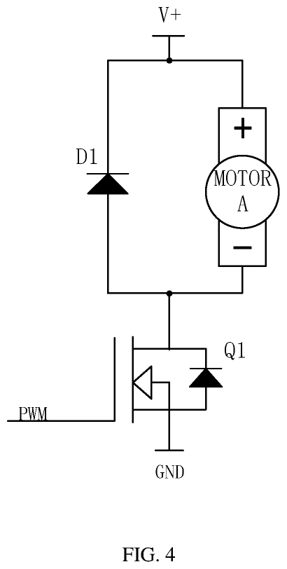

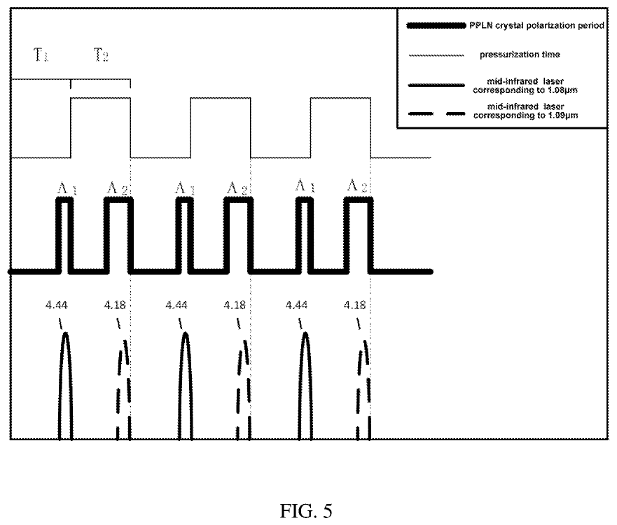

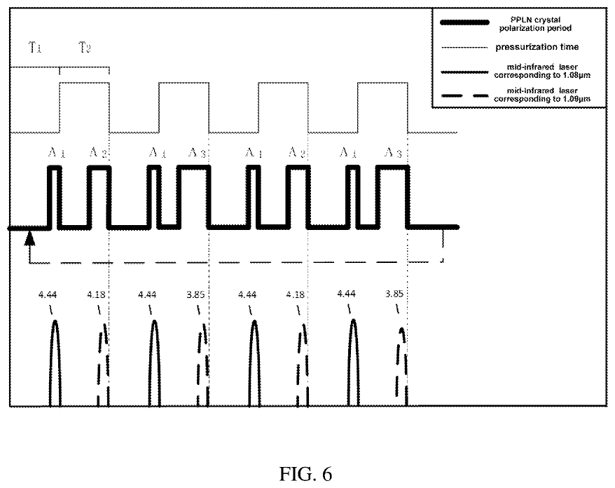

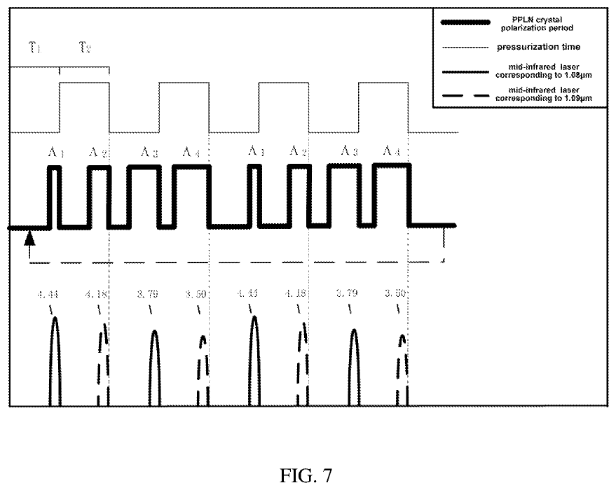

In FIG. 1, the structural components indicated by various reference numerals are:
1: 813 nm semiconductor pumping source; 2: energy transmitting optical fiber;
3: first focusing lens; 4: second focusing lens;
5: first 45-degree beam splitter; 6: mid-infrared idle frequency light output mirror;
7: multi-period Nd:MgO:PPLN polarized crystal; 8: Servo motor;
9: mid-infrared idle frequency light total reflection mirror;
10: MCU (Microprogrammed Control Unit);
11: second 45-degree beam splitter; 12: electro-optical crystal;
13: 1093 nm fundamental frequency light total reflection mirror;
14: 1084 nm fundamental frequency light total reflection mirror.

FIG. 2 is a schematic structural view of a servo matching control mid-infrared differential dual-wavelength laser based on multi-period ND:MGO:PPLN according to another embodiment of the present disclosure.

FIG. 3 is a control flow chart of a high-speed signal switching system according to an embodiment of the present disclosure.

FIG. 4 is a circuit diagram of a driver of a servo motor according to an embodiment of the present disclosure.

FIG. 5 is a graph showing the relationship between pressurization time, crystal period and wavelength of parametric light according to an embodiment of the present disclosure.

FIG. 6 is a graph showing the relationship between pressurization time, crystal period and wavelength of parametric light according to another embodiment of the present disclosure.

FIG. 7 is a graph showing the relationship between pressurization time, crystal period and wavelength of parametric light according to yet another embodiment of the present disclosure.

### DETAILED DESCRIPTION OF EMBODIMENTS

Hereinafter, exemplary embodiments of the present disclosure will be described in detail with reference to the accompanying drawings in order that those skilled in the art can easily implement them. Also, for clarity, those parts that are not related to describing the exemplary embodiments are omitted in the drawings.

In the present disclosure, it should be understood that terms such as “comprising”, “including” or “having” are intended to indicate the presence of features, numbers, steps, actions, components, parts or combinations thereof disclosed in the specification, but are not intended to exclude one or a plurality of other features, numbers, steps, actions, components, parts or combinations thereof.

In addition, it should be noted that, in the case of no conflict, the embodiments and the features in the embodiments in the present disclosure can be combined with each other. The present disclosure will be described in detail below with reference to the accompanying drawings and embodiments.

FIG. 1 is a schematic structural view of a servo matching control mid-infrared differential dual-wavelength laser based on multi-period ND:MGO:PPLN according to an embodiment of the present disclosure. As shown in FIG. 1, the laser includes an 813 nm semiconductor pumping source 1, an energy transmitting optical fiber 2, a first focusing lens 3, a second focusing lens 4, a first 45-degree beam splitter 5, a mid-infrared idle frequency light output mirror 6, a multi-period Nd:MgO:PPLN polarized crystal 7, a servo motor 8, a mid-infrared idle frequency light total reflection mirror 9, a MCU (Microprogrammed Control Unit) 10, a second 45 degree beam splitter 11, an electro-optical crystal 12, a 1093 nm fundamental frequency light total reflection mirror 13, and a 1084 nm fundamental frequency light total reflection mirror 14.

The 813 nm semiconductor pumping source 1, the energy transmitting optical fiber 2, the first focusing lens 3, the second focusing lens 4, the first 45-degree beam splitter 5, the mid-infrared idle frequency light output mirror 6, the multi-period Nd:MgO:PPLN polarized crystal 7, the servo motor 8, the mid-infrared idle frequency light total reflection mirror 9, the MCU (Microprogrammed Control Unit) 10, the second 45-degree beam splitter 11, the electro-optical crystal 12, the 1093 nm fundamental frequency light total reflection mirror 13 are sequentially placed from right to left in a straight cavity of the laser.

The 1084 nm fundamental frequency light total reflection mirror 14 is placed in a bent-shape cavity of the laser, corresponding to the position of the second 45-degree beam splitter 11, such that the second 45-degree beam splitter 11 can reflect the incident light to the 1084 nm fundamental frequency light total reflection mirror 14.

In detail, the 813 nm semiconductor pumping source 1 is configured to emit pumping light; the energy transmitting optical fiber 2 is configured to sequentially transmit the pumping light to the first focusing lens 3 and the second focusing lens 4; the first focusing lens 3 and the second focusing lens 4 are configured to form a zoom coupling lens group to adjust the size of pumping light spot focused on an end face of the multi-period Nd:MgO:PPLN polarized crystal 7, for example, the pumping light may be adjusted to a pumping light spot with a radius of 400 μm, so as to be transmitted through the first 45-degree beam splitter 5 and the mid-infrared idle frequency light output mirror 6 and focused on the end face of the multi-period Nd:MgO:PPLN polarized crystal 7. The first 45-degree beam splitter 5 is configured to allow the pumping light to be transmitted through and reflect mid-infrared idle frequency light; the mid-infrared idle frequency light output mirror 6 is configured to allow the pumping light to be transmitted through, reflect 1084 nm/1093 nm fundamental frequency light, and output mid-infrared idle frequency light; The multi-period Nd:MgO:PPLN polarized crystal 7 is used as a gain medium and a frequency conversion medium for generating 1084 nm/1093 nm fundamental frequency light and mid-infrared idle frequency light, it is configured to generate 1084 nm/1093 nm fundamental frequency light under the pumping action of the pumping light, and finally output mid-infrared idle frequency light. Herein, the wavelength of the mid-infrared idle frequency light output by the laser is related to the relaxation oscillation path of the 1084 nm/1093 nm fundamental frequency light between the corresponding crystal periodic channels. The servo motor 8 is configured to realize precise reciprocal movement of the multi-period Nd:MgO:PPLN polarized crystal 7 under the control of the MCU (Microprogrammed Control Unit) 10, so as to realize switching of crystal periods; the mid-infrared idle frequency light total reflection mirror 9 is configured to allow the 1084 nm/1093 nm fundamental frequency light to be transmitted through, and reflect the mid-infrared idle frequency light; the MCU (Microprogrammed Control Unit) 10 is configured to send a PWM signal to the servo motor 8 to control the rotation speed of the servo motor 8 when receiving a modulation signal, and always send electrical signals to the electro-optical crystal 12 at a certain frequency. The second 45-degree beam splitter 11 is configured to reflect the 1084 nm fundamental frequency light to the 1084 nm fundamental frequency light total reflection mirror 14, and allow the 1093 nm fundamental frequency light to be transmitted to the 1093 nm fundamental frequency light total reflection mirror 13; the electro-optical crystal 12 is placed between the second 45-degree beam splitter 11 and the 1093 nm fundamental frequency light total reflection mirror 13 to improve the stimulated emission area for the 1093 nm fundamental frequency light, and realize a mid-infrared differential wavelength output; the 1093 nm fundamental frequency light total reflection mirror 13 is configured to reflect the 1093 nm fundamental frequency light.

In an embodiment of the present disclosure, the 813 nm semiconductor pumping source has a wavelength of 813 nm, a fiber core radius of 200 μm, and a numerical aperture of 0.22.

In an embodiment of the present disclosure, the first 45-degree beam splitter 5 is coated at its right end with a high-transmittance film for 813 nm fundamental frequency light and at its left end with a high-reflection film for mid-infrared idle frequency light.

In an embodiment of the present disclosure, the mid-infrared idle frequency light output mirror 6 is a flat mirror coated with a high-transmittance film for 1084 nm/1093 nm fundamental-band light and idle frequency light.

In an embodiment of the present disclosure, the multi-period Nd:MgO:PPLN polarized crystal 7 is cut in an a-axis, with a crystal size of: thickness×width×length=2 mm×6 mm×40 mm, a doping concentration of MgO is set to 5%, and a doping concentration of Nd³⁺ ions is set to 0.4%, and the multi-period Nd:MgO:PPLN polarized crystal 7 is coated at two ends with a high-transmittance film for pumping light and fundamental frequency light and a high-transmittance film for idle frequency light, for example, an antireflection film for 813 nm pumping light and 1080-1090 nm fundamental frequency light band and a high-transmittance film for 3000 nm-5000 nm idle frequency light band. The interior of the crystal material of the multi-period Nd:MgO:PPLN polarized crystal 7 includes a top layer, a channel layer and a bottom layer in order from top to bottom, wherein the multi-period PPLN crystal refers to one crystal on which different periods are polarized in turn, generally there may be more than a dozen periods, the thicknesses of the top layer and the bottom layer of the multi-period Nd:MgO:PPLN polarized crystal 7 are 1 mm, the channel layer contains 5 channels, the polarization period length of the channels is between 28 μm and 33 μm, the thickness of the channels is 1.2 mm, the different channels are separated by spacer layer, the thickness of the spacer layers is 0.8 mm, the bottom surface of the bottom layer is attached to a temperature control device, and the temperature is controlled at 25° C.

Herein, an idle frequency light resonant cavity, a 1093 nm fundamental frequency light resonant cavity and a 1084 nm fundamental frequency light resonant cavity are built in the straight cavity and the bent-shape cavity of the mid-infrared differential dual-wavelength laser, specifically, the mid-infrared idle frequency light frequency output mirror 6, the mid-infrared idle frequency light total reflection mirror 9 and the multi-period Nd:MgO:PPLN crystal 7 constitute an idle frequency light resonant cavity; the first 45-degree beam splitter 5, the idle frequency light resonant cavity, the second 45-degree beam splitter 11 and the 1084 nm fundamental frequency light total reflection mirror 14 constitute a 1084 nm fundamental frequency light resonant cavity; the first 45-degree beam splitter 5, the idle frequency light resonant cavity, and the second 45-degree beam splitter 11, the electro-optical crystal 12 and the 1093 nm fundamental frequency light total reflection mirror 13 constitute a 1093 nm fundamental frequency light resonant cavity.

In an embodiment of the present disclosure, the mid-infrared idle frequency light total reflection mirror 9 is a flat mirror coated with a high-reflection film for idle frequency light and a high-transmittance film for 1084 nm/1093 nm fundamental frequency light.

In an embodiment of the present disclosure, the second 45-degree beam splitter 11 is coated with a high-reflection film for 1084 nm fundamental frequency light and a high-transmittance film for 1093 nm fundamental frequency light.

In an embodiment of the present disclosure, the electro-optical crystal 12 is coated with a 1093 nm laser anti-reflection film, and a V/4 voltage can be applied to both ends of the electro-optical crystal.

In an embodiment of the present disclosure, the 1093 nm fundamental frequency light total reflection mirror 13 and the 1084 nm fundamental frequency light total reflection mirror 14 are plano-concave mirrors coated with 1084 nm/1093 nm high-reflection films at their concaves.

Based on the above technical solutions, the 813 nm semiconductor pumping source 1 emits pumping light with a wavelength of 813 nm, and the multi-period Nd:MgO:PPLN polarized crystal 7 absorbs the pumping light with the main peak wavelength, and the pumping light is transmitted through the energy transmitting optical fiber 2, the first focusing lens 3, the second focusing lens 4 and the first 45-degree beam splitter 5, and is focused onto the multi-period Nd:MgO:PPLN polarized crystal 7 from the right end to form a single-end pumping mode, and the multi-period Nd:MgO:PPLN polarized crystal 7 absorbs the pumping light and then forms population inversion. When the gain is greater than the loss in the 1084 nm/1093 nm fundamental frequency light resonant cavity, the multi-period Nd:MgO:PPLN polarized crystal 7 is stimulated to emit 1084 nm/1093 nm fundamental frequency light. If the electro-optical crystal 12 is not loaded with voltage, and the gain of 1084 nm fundamental frequency light is greater than that of 1093 nm fundamental frequency light, then the 1084 nm fundamental frequency light will be reflected by the 1084 nm fundamental frequency light total reflection mirror 14 into the idle frequency light resonant cavity to participate in nonlinear frequency conversion, and finally output the mid-infrared idle frequency light corresponding to the 1084 nm fundamental frequency light; if the electro-optical crystal 12 is loaded with voltage, and the gain of the 1093 nm fundamental frequency light is greater than that of the 1084 nm fundamental frequency light, then the 1093 m fundamental frequency light will be reflected by the 1093 nm fundamental frequency total reflection mirror 13 into the idle frequency light resonant cavity to participate in nonlinear frequency conversion, and finally output the mid-infrared idle frequency light corresponding to the 1093 m fundamental frequency light.

FIG. 1 shows the propagation paths of the 1084 nm fundamental frequency light and its corresponding mid-infrared idle frequency light in the laser, where the solid line represents the 1084 nm fundamental frequency light and its corresponding mid-infrared idle frequency light, and the dashed line represents the 1093 nm fundamental frequency light. FIG. 2 shows the propagation path of the 1093 nm fundamental frequency light and its corresponding mid-infrared idle frequency light in the laser after the multi-period Nd:MgO:PPLN polarized crystal 7 is translated upwards, where the solid line represents the 1093 nm fundamental frequency light and its corresponding mid-infrared idle frequency light, and the dotted line represents 1084 nm fundamental frequency light.

Herein, the control flow chart of the high-speed signal switching system of the MCU (Microprogrammed Control Unit) 10 is shown in FIG. 3, and the circuit diagram of the driver of the servo motor 8 is shown in FIG. 4. When the MCU (Microprogrammed Control Unit) 10 receives a modulation signal, it quickly outputs a PWM (pulse width modulation) signal to control the rotation speed of the servo motor 8. A high-speed eccentric disk is used to greatly improve the reciprocal movement speed of the multi-period Nd:MgO:PPLN polarized crystal 7, to adapt to high repetition frequency signal switching. The rotation speed and rotor position of the servo motor 8 are detected by a photoelectric rotary encoder. When the motor turns to a predetermined position, the MCU (Microprogrammed Control Unit) 10 outputs a control signal to turn on or off a Q switch, and the output of the corresponding 1084 nm fundamental frequency light or 1093 nm fundamental frequency light is obtained, and a mid-infrared differential dual-wavelength laser output with matching wavelengths is obtained through the corresponding polarization periodic channels of the multi-period Nd:MgO:PPLN polarized crystal 7. Herein, the relaxation oscillation of different fundamental frequency outputs in different polarization periodic channels will yield multi-wavelength mid-infrared laser output, therefore it is necessary to actively select mid-infrared lasers that can be matched into differential dual-wavelengths.

The fundamental frequency light forms a pumping for the multi-period Nd:MgO:PPLN polarized crystal 7 at the same time. Relying on the design of the mid-infrared idle frequency light total reflection mirror and the mid-infrared idle frequency light output mirror and the design of cavity length of the idle frequency light resonant cavity, it ensures that the beam waist of light spot of the oscillating idle frequency light coincides with the beam waist of light spot of the fundamental frequency light. When the power of the fundamental frequency light pumping is greater than the start-oscillation threshold of the idle frequency light resonant cavity, it forms synchronously-operated and stably-oscillating mid-infrared idle frequency light, and finally the mid-infrared idle frequency light is output through the mid-infrared idle frequency light output mirror 6 and refracted and output by the first 45-degree beam splitter 5.

The pressurization time of the electro-optical crystal 12 is determined by a preset Q-switch frequency interval. When no voltage is loaded, the 1084 nm/1093 nm fundamental frequency lights exist simultaneously, but only the 1084 nm fundamental frequency light participates in frequency conversion, and the mid-infrared laser generated by the 1084 nm fundamental frequency light is output. When the electro-optical crystal 12 is loaded with voltage, the polarization direction of the 1093 nm fundamental frequency light changes, so that the 1093 nm fundamental frequency light can also participate in frequency conversion. At this time, the gain of the 1093 nm fundamental frequency light is higher than that of the 1084 nm fundamental frequency light, and the output mid-infrared laser comes from the participation of 1093 nm fundamental frequency light in the frequency conversion.

When high-power pumping injection happens, the gain of the 1093 nm fundamental frequency light is greater than that of the 1084 nm fundamental frequency light, but the 1093 nm o-light laser cannot participate in light parametric oscillation because it does not meet the quasi-phase matching frequency conversion conditions. At this time, although the gain of the 1084 nm fundamental frequency light is relatively low, it can also participate in light parametric oscillation, and output the mid-infrared laser generated by the 1084 nm fundamental frequency light. When the 1084 nm fundamental frequency light oscillates in the channel having Λ₁=28 nm of crystal period, it outputs idle frequency light with a wavelength of 4.449 μm.

When the MCU (Microprogrammed Control Unit) 10 sends a control signal to turn on the electro-optical crystal 12, and when a λ/4 voltage is inputted to the two ends of the electro-optical crystal 12, the 1093 nm fundamental frequency light has a larger stimulated emission area under the high-power pumping mechanism, has a higher gain, the 1093 nm fundamental frequency light is incident to the multi-period Nd:MgO:PPLN polarized crystal 7 through the mid-infrared idle frequency light total reflection mirror 9, and under the action of the 1093 nm fundamental frequency light, the mid-infrared idle frequency light resonant cavity reaches the start-oscillation threshold, an oscillated 4.492 μm mid-infrared idle frequency light is synchronously generated and is output by the mid-infrared idle frequency light output mirror 6. When the λ/4 voltage is removed from both ends of the electro-optical crystal 12, the 1093 nm fundamental frequency light gradually disappears due to the inability to obtain gain. At this time, in the process of mode competition of dual wavelengths between 1084 nm and 1093 nm, the 1084 nm fundamental frequency light obtains high gain, the 1084 nm fundamental frequency light participates in the nonlinear frequency conversion, the oscillated 4.492 μm idle frequency light is synchronously generated and is output by the mid-infrared idle frequency light output mirror 6. During this process, a mid-infrared differential dual-wavelength laser of 4.449 μm and 4.492 μm is formed.

The MCU (Microprogrammed Control Unit) 10 receives the modulation signal of the peak and trough parameters of the absorption spectrum of the gas to be detected, to realize the linkage of the frequency interval of the Q-switch and the servo control system. The rotor position and rotation speed fed back by the rotary encoder is monitored in real time through the MCU (Microprogrammed Control Unit) 10, so as to timely adjust the pressurization time at both ends of the electro-optical crystal 12, thereby realizing the output of the mid-infrared differential wavelength laser based on multi-period Nd:MgO:PPLN polarized crystal 7. According to actual demand, when MCU (Microprogrammed Control Unit) 10 receives the modulation signals that have operating frequency of 10 KHz and alternately switched periods of Λ₁ and Λ₂, the MCU (Microprogrammed Control Unit) 10 may automatically output PWM pulse signals to the servo motor driver to make the servo motor rotate to a corresponding position to realize the precise positioning of the crystal cycle channel and realize wavelength matching. At this time, the pulse interval is 100 s, presuming that the time during which the electro-optical crystal 12 is not loaded with voltage is T1, and the time during which the voltage is applied is T₂, if T1 and T 2 are set to 100 s at the same time, the relationship between frequency interval, crystal period and idle frequency light wavelength is shown in FIG. 5. In this process, a differential dual-wavelength mid-infrared laser of 4.44 μm and 4.18 μm is formed. This wavelength range matches the peak and trough of the gas absorption spectrum of CO₂ gas molecules.

The present disclosure can realize mid-infrared differential dual-wavelength laser in three output states, as shown in FIG. 5, FIG. 6, and FIG. 7. State I: different fundamental frequency lights oscillate in different periodic channels to output the combination of dual-wavelength lasers, such as 4.13 μm and 3.85 μm differential dual-wavelength group, matching the peak and trough of the gas absorption spectrum of SO₂ gas molecules; State II: the output of differential dual-wavelength laser in the same crystal periodic channel, such as 3.50 μm and 3.42 μm differential dual-wavelength group, matching the peak and trough of the gas absorption spectrum of NO₂ gas molecules; State III: the same fundamental frequency light oscillates across periodic channels to output the combination of dual-wavelength lasers. By selecting and combining the output wavelengths, the peak and trough of the absorption spectrum of the gas molecules to be detected are matched.

To sum up, the purpose of the present disclosure is to solve the problem that prior art systems cannot flexibly match and switch crystal periodic channels to output mid-infrared differential dual-wavelength laser in the process of self-light parametric oscillation based on multi-period Nd:MgO:PPLN polarized crystal. An idle frequency light resonant cavity and a 1084 nm/1093 nm fundamental frequency light resonant cavity are built in the straight cavity and bent-shape cavity of the laser, the MCU (Microprogrammed Control Unit) outputs a PWM (pulse width modulation) signal to control the rotation speed of the servo motor to achieve fast and accurate switching between crystal periodic channels, the MCU (Microprogrammed Control Unit) is used to set the frequency interval to control the pressurization time of the electro-optical crystal, the servo control system selects different differential dual-wavelength combinations to match the peak and trough of the absorption spectrum of the gas molecules to be detected, and it ensures the application index, meanwhile it realizes a servo matching control mid-infrared differential dual-wavelength laser that has multi-channel integration of mid-infrared differential wavelength laser, free matching control of wavelength, and structurally compact integration.

The above description only refers to optional embodiments of the present disclosure and an illustration of the applied technical principle. Those skilled in the art should understand that the scope of invention involved in the present disclosure is not limited to the technical solutions formed by the specific combination of the above-mentioned technical features, but should cover other technical solutions formed by any combination of the above-mentioned technical features or equivalent features thereof without departing from the inventive concept, for example, the technical solutions formed by replacing the above-mentioned features with technical features with similar functions disclosed in the present disclosure (but not limited to).

What is claimed is:

1. A servo matching control mid-infrared differential dual-wavelength laser based on multi-period ND:MGO:PPLN, comprising: an 813 nm semiconductor pumping source, an energy transmitting optical fiber, a first focusing lens, a second focusing lens, a first 45-degree beam splitter, a mid-infrared idle frequency light output mirror, a multi-period Nd:MgO:PPLN polarized crystal, a servo motor, a mid-infrared idle frequency light total reflection mirror, a microprogrammed control unit, a second 45-degree beam splitter, an electro-optical crystal, a 1093 nm fundamental frequency light total reflection mirror, and a 1084 nm fundamental frequency light total reflection mirror,
wherein the 813 nm semiconductor pumping source, the energy transmitting optical fiber, the first focusing lens, the second focusing lens, the first 45-degree beam splitter, the mid-infrared idle frequency light output mirror, the multi-period Nd:MgO:PPLN polarized crystal, the servo motor, the mid-infrared idle frequency light total reflection mirror, the microprogrammed control unit, the second 45-degree beam splitter, the electro-optical crystal, and the 1093 nm fundamental frequency light total reflection mirror are sequentially placed from right to left in a straight cavity of the laser;
wherein the 1084 nm fundamental frequency light total reflection mirror is placed in a bent-shape cavity of the laser, corresponding to a position of the second 45-degree beam splitter, such that that the second 45-degree beam splitter reflects incident light to the 1084 nm fundamental frequency light total reflection mirror.

2. The laser according to claim 1, wherein the 813 nm semiconductor pumping source is configured to emit pumping light;
the energy transmitting optical fiber is configured to sequentially transmit the pumping light to the first focusing lens and the second focusing lens;
the first focusing lens and the second focusing lens are configured to form a zoom coupling lens group to adjust a size of pumping light spot focused on an end face of the multi-period Nd:MgO:PPLN polarized crystal;
the first 45-degree beam splitter is configured to allow the pumping light to be transmitted through and reflect mid-infrared idle frequency light;
the mid-infrared idle frequency light output mirror is configured to allow the pumping light to be transmitted through, reflect 1084 nm/1093 nm fundamental frequency light, and output mid-infrared idle frequency light;
the multi-period Nd:MgO:PPLN polarized crystal is configured to generate 1084 nm/1093 nm fundamental frequency light under a pumping action of the pumping light, and output mid-infrared idle frequency light;
the servo motor is configured to realize reciprocal movement of the multi-period Nd:MgO:PPLN polarized crystal under a control of the microprogrammed control unit, so as to realize switching of crystal periods;
the mid-infrared idle frequency light total reflection mirror is configured to allow the 1084 nm/1093 nm fundamental frequency light to be transmitted through, and reflect the mid-infrared idle frequency light;
the microprogrammed control unit is configured to control a rotation speed of the servo motor, and send electrical signals to the electro-optical crystal;
the second 45-degree beam splitter is configured to reflect the 1084 nm fundamental frequency light to the 1084 nm fundamental frequency light total reflection mirror, and allow the 1093 nm fundamental frequency light to be transmitted to the 1093 nm fundamental frequency light total reflection mirror;
the electro-optical crystal is configured to improve a stimulated emission area for the 1093 nm fundamental frequency light, and realize a mid-infrared differential wavelength output;
the 1093 nm fundamental frequency light total reflection mirror is configured to reflect the 1093 nm fundamental frequency light.

3. The laser according to claim 1, wherein the mid-infrared idle frequency light output mirror, the mid-infrared idle frequency light total reflection mirror and the multi-period Nd:MgO:PPLN polarized crystal constitute an idle frequency light resonant cavity;
the first 45-degree beam splitter, the idle frequency light resonant cavity, the second 45-degree beam splitter and the 1084 nm fundamental frequency light total reflection mirror constitute a 1084 nm fundamental frequency light resonant cavity;
the first 45-degree beam splitter, the idle frequency light resonant cavity, the second 45-degree beam splitter, the electro-optical crystal, and the 1093 nm fundamental frequency light total reflection mirror constitute a 1093 nm fundamental frequency light resonant cavity.

4. The laser according to claim 1, wherein the 813 nm semiconductor pumping source has a wavelength of 813 nm, a fiber core radius of 200 μm, and a numerical aperture of 0.22.

5. The laser according to claim 1, wherein the first 45-degree beam splitter is coated with a high-transmittance film for 813 nm fundamental frequency light and a high-reflection film for mid-infrared idle frequency light.

6. The laser according to claim 1, wherein the mid-infrared idle frequency light output mirror is a flat mirror coated with a high-transmittance film for 1084 nm/1093 nm fundamental frequency light and idle frequency light.

7. The laser according to claim 1, wherein the multi-period Nd:MgO:PPLN polarized crystal is cut in an a-axis, with a crystal size of: thickness×width×length=2 mm×6 mm×40 mm, a doping concentration of MgO is set to 5%, and a doping concentration of Nd³⁺ ions is set to 0.4%, and the multi-period Nd:MgO:PPLN polarized crystal is coated at two ends with a high-transmittance film for pumping light and fundamental frequency light and a high-transmittance film for idle frequency light.

8. The laser according to claim 1, wherein the mid-infrared idle frequency light total reflection mirror is a flat mirror coated with a high-reflection film for idle frequency light and a high-transmittance film for 1084 nm/1093 nm fundamental frequency light; the 1093 nm fundamental frequency light total reflection mirror and the 1084 nm fundamental frequency light total reflection mirror are plano-concave mirrors coated with high-reflection films for 1084 nm/1093 nm fundamental frequency light.

9. The laser according to claim 1, wherein the second 45-degree beam splitter is coated with a high-reflection film for 1084 nm fundamental frequency light and a high-transmittance film for 1093 nm fundamental frequency light.

10. The laser according to claim 1, wherein the electro-optical crystal is coated with a 1093 nm laser anti-reflection film, and a λ/4 voltage is applied to two ends of the electro-optical crystal.

11. The laser according to claim 2, wherein the mid-infrared idle frequency light output mirror, the mid-infrared idle frequency light total reflection mirror and the multi-period Nd:MgO:PPLN polarized crystal constitute an idle frequency light resonant cavity;
the first 45-degree beam splitter, the idle frequency light resonant cavity, the second 45-degree beam splitter and the 1084 nm fundamental frequency light total reflection mirror constitute a 1084 nm fundamental frequency light resonant cavity;
the first 45-degree beam splitter, the idle frequency light resonant cavity, the second 45-degree beam splitter, the electro-optical crystal, and the 1093 nm fundamental frequency light total reflection mirror constitute a 1093 nm fundamental frequency light resonant cavity.

12. The laser according to claim 2, wherein the 813 nm semiconductor pumping source has a wavelength of 813 nm, a fiber core radius of 200 μm, and a numerical aperture of 0.22.

13. The laser according to claim 3, wherein the 813 nm semiconductor pumping source has a wavelength of 813 nm, a fiber core radius of 200 μm, and a numerical aperture of 0.22.

14. The laser according to claim 2, wherein the first 45-degree beam splitter is coated with a high-transmittance film for 813 nm fundamental frequency light and a high-reflection film for mid-infrared idle frequency light.

15. The laser according to claim 3, wherein the first 45-degree beam splitter is coated with a high-transmittance film for 813 nm fundamental frequency light and a high-reflection film for mid-infrared idle frequency light.

16. The laser according to claim 4, wherein the first 45-degree beam splitter is coated with a high-transmittance film for 813 nm fundamental frequency light and a high-reflection film for mid-infrared idle frequency light.

17. The laser according to claim 2, wherein the mid-infrared idle frequency light output mirror is a flat mirror coated with a high-transmittance film for 1084 nm/1093 nm fundamental frequency light and idle frequency light.

18. The laser according to claim 3, wherein the mid-infrared idle frequency light output mirror is a flat mirror coated with a high-transmittance film for 1084 nm/1093 nm fundamental frequency light and idle frequency light.

19. The laser according to claim 4, wherein the mid-infrared idle frequency light output mirror is a flat mirror coated with a high-transmittance film for 1084 nm/1093 nm fundamental frequency light and idle frequency light.

20. The laser according to claim 5, wherein the mid-infrared idle frequency light output mirror is a flat mirror coated with a high-transmittance film for 1084 nm/1093 nm fundamental frequency light and idle frequency light.
